(19) United States
(12) Patent Application Publication
(10) Pub. No.: US 2014/0141361 A1
(43) Pub. Date: May 22, 2014

(54) Surface Control Apparatuses Reducing Print Defects and Methods of Using Same

(71) Applicants: Yu Liu, Mississauga (CA); Gregory McGuire, Oakville (CA); Sarah J Vella, Milton (CA); Richard A Klenkler, Oakville (CA); Vladislav Skorokhod, Mississauga (CA); Nan-Xing Hu, Oakville (CA); Yiliang Wu, Mississauga (CA)

(72) Inventors: Yu Liu, Mississauga (CA); Gregory McGuire, Oakville (CA); Sarah J Vella, Milton (CA); Richard A Klenkler, Oakville (CA); Vladislav Skorokhod, Mississauga (CA); Nan-Xing Hu, Oakville (CA); Yiliang Wu, Mississauga (CA)

(73) Assignee: XEROX CORPORATION, NORWALK, CT (US)

(21) Appl. No.: 13/680,533

(22) Filed: Nov. 19, 2012

(51) Int. Cl. G03G 15/00

(52) U.S. Cl. CPC G03G 5/14708; Y10S 977/755; B82Y 30/00
USPC 430/56; 430/66; 430/132; 977/755; 399/159

(57) ABSTRACT

Surface control apparatuses including an imaging member having a charge retentive surface for developing an electrostatic latent image thereon. The imaging member including a substrate, a photoconductive layer disposed on the substrate, and a surface control (SC) layer disposed on the outer surface of the imaging member. Image forming apparatuses having such surface control apparatuses installed and methods of reducing print defects using such image forming apparatuses.

### CROSS-REFERENCE TO RELATED APPLICATIONS

Attention is directed to U.S. patent application Ser. No. 13/020,738, filed Feb. 3, 2011, to Hu et al.; Ser. No. 13/192,215, filed Jul. 27, 2011, to Hu et al.; Ser. No. 13/192,252, filed Jul. 27, 2011, to Vella et al.; Ser. No. 13/279,981, filed Oct. 24, 2011, to Vella et al.; Ser. No. 13/286,905, filed Nov. 1, 2011, to McGuire et al.; Ser. No. 13/326,414, filed Dec. 15, 2011, to McGuire et al.; Ser. No. 13/426,836, filed Mar. 22, 2012, to Vella et al.; and Ser. No. 13/437,472, filed Apr. 2, 2012, to Liu et al. The contents of these patent applications are hereby incorporated by reference in their entirety.

### BACKGROUND

Embodiments herein relate generally to image forming apparatuses (e.g., electrophotographic apparatuses) and components for use therein. Certain embodiments are drawn to methods of reducing printing defects by an image forming apparatus. Some embodiments are drawn to improved imaging members (e.g., photoreceptors) comprising a surface control layer having a thickness of between about 5 nm and about 65 nm throughout.

In electrophotographic printing, the charge retentive surface, known as a photoreceptor, is electrostatically charged, and then exposed to a light pattern of an original image to selectively discharge the surface in accordance therewith. The resulting pattern of charged and discharged areas on the photoreceptor form an electrostatic charge pattern, known as a latent image, conforming to the original image. The latent image is developed by contacting it with a finely divided electrostatically attractable powder known as toner. Toner is held on the image areas by the electrostatic charge on the photoreceptor surface. Thus, a toner image is produced in conformity with a light image of the original being reproduced or printed. The toner image can then be transferred to a substrate (e.g., paper) directly or through the use of an intermediate transfer member, and the image affixed thereto to form a permanent record of the image to be reproduced or printed. Subsequent to development, excess toner left on the charge retentive surface is cleaned from the surface. The process is useful for light lens copying from an original or printing electronically generated or stored originals such as with a raster output scanner (ROS), where a charged surface can be imagewise discharged in a variety of ways.

The described electrophotographic copying process is well known and is commonly used for light lens copying of an original document. Analogous processes also exist in other electrophotographic printing applications such as, for example, digital laser printing or ionographic printing and reproduction where charge is deposited on a charge retentive surface in response to electronically generated or stored images.

Multilayered photoreceptors or imaging members have at least two layers, and can include a support/substrate, a photoconductive layer (comprising one or two layers), an optional undercoat layer (sometimes referred to as a “charge blocking layer” or “hole blocking layer”), an optional adhesive layer, and an optional overcoating layer in either a flexible belt form, a cylinder configuration or a rigid drum configuration, among other layers and configurations known in the art.

A single layered type photoconductive layer has a binder resin, a charge generating material, a hole transporting material, and an electron transporting material (ETM) in a single layer. In the multilayer configuration of the photoconductive layer, the active layers of the photoreceptor are a charge generation layer (CGL) and a charge transport layer (CTL). Enhancement of charge transport across these layers provides better photoreceptor performance. Multilayered flexible photoreceptor members can include an anti-curl layer on the backside of the support, opposite to the side of the electrically active layers, to render the desired photoreceptor flatness.

Long life photoreceptors can result in significant run-cost reductions. Improvement of long life photoreceptors has included the development of low wear protective overcoat layers. These layers help facilitate dramatically reduced surface wear. However, these layers also often introduce a host of unwanted issues caused by the poor interaction between the cleaning blade and the overcoat layer. The overcoats can be associated with extremely high initial torque and can result in print defects, poor cleaning, cleaning blade damage/failure and cleaning blade flip, and, in some cases, the high initial torque can prevent the drum from turning and can cause a motor fault.

Interactions between the photoreceptor drum surface (with or without an overcoat) and contacting xerographic components, such as a cleaning blade, can result in a number of failure modes which have a direct impact on image quality and printer operation. If the torque exceeds the limits of the drive motor there will be a forced shutdown of the printer. High torque can also induce mechanical stress and vibration in the cleaning blade, which can be manifested as deformation and acoustic squeaking of the blade. This can reduce the cleaning efficiency of the blade and can even damage the blade surface enough to permit permanent toner contamination of the photoreceptor. The contamination is often characterized by lines of toner around the circumference of the photoreceptor drum and register with the damaged areas of the cleaning blade.

Methods/systems developed to deal with these issues, include applying a fine solid powder to the photoreceptor surface to lubricate the cleaning blade. However, solid powder lubricants have several emerging problems such as scattered exposure light, inevitable damage to the bias charge roll (a roller used to create a charge on the photoreceptor surface, “BCR”) and the photoreceptor after long-term running, and increased non-uniformity of surface charging voltage on the photoreceptor. (See FIG. 4.)

It would be desirable to provide long life photoreceptors that enable blade conformation to the photoreceptor and that reduce printing defects by an image forming apparatus.

### SUMMARY

Certain embodiments are drawn to image forming apparatuses comprising an imaging member, an application member, and optionally a charging unit. The imaging member can have a charge retentive surface for developing an electrostatic latent image thereon and comprises a substrate, a photoconductive layer disposed on the substrate, and a surface control (SC) layer. The surface control layer can be disposed on the outer surface of the imaging member and have a thickness between about 5 nm and about 65 nm throughout. In some embodiments, the SC layer can have a thickness between about 8 nm and about 65 nm throughout, between about 10 nm and about 65 nm throughout, between about 20 nm and about 65 nm throughout, or between about 30 nm and about 65 nm throughout. The charging unit can be used to apply an electrostatic charge on the imaging member. The application member can be used to apply the SC layer to the surface of the imaging member.

Some embodiments are drawn to surface control apparatuses comprising an imaging member. The imaging member can have a charge retentive surface for developing an electrostatic latent image thereon. In embodiments the imaging member comprises a substrate, a photoconductive layer disposed on the substrate, and a surface control (SC) layer disposed on the outer surface of the imaging member. The surface control layer can have a thickness between about 5 nm and about 65 nm throughout.

Embodiments herein are drawn to methods for reducing printing defects by an image forming apparatus comprising an imaging member. The methods comprise applying to the outer surface of the imaging member a surface control (SC) layer at a thickness of between about 5 nm and about 65 nm throughout.

Certain embodiments can suppress the phenomena of background darkening and streaking associated with some existing surface control system (SCS) technologies.

### BRIEF DESCRIPTION OF THE DRAWINGS

FIG. 1 is a cross-sectional view of an imaging member in a drum configuration according to certain embodiments.

FIG. 2 is a cross-sectional view of an imaging member in a drum configuration according to some embodiments.

FIG. 3 is a cross-sectional view of an imaging member in a drum configuration according to certain embodiments.

FIG. 4 depicts the surface of a photoreceptor (PR) having a known solid powder surface control system (SCS) or a photoreceptor (PR) having a liquid SCS of embodiments herein. FIG. 4 a) illustrates the surface of a photoreceptor (PR) having a solid powder surface control system (SCS) known in the art and the surface of a photoreceptor having a liquid surface control system (SCS), as in embodiments herein. FIG. 4 b) depicts the surface of a photoreceptor having a solid powder SCS and a bias charge roll (BCR). FIG. 4 c) depicts the surface charging voltage profile at the surface of a photoreceptor (PR) having a solid powder SCS and at the surface of a photoreceptor having a liquid SCS (described below).

FIG. 5 illustrates two force-distance curves prepared by atomic force microscopy (AFM) to measure thickness and uniformity of a surface control system of embodiments herein (5b) as compared to a control (5a).

FIG. 6 depicts a print test performed using a photoreceptor drum having a very thick (microns thick) paraffin oil layer on its surface.

FIG. 7 depicts a print test performed using a photoreceptor drum having an 8.2 nm±1.5 nm (thickness and uniformity as measured by AFM) paraffin oil layer on its surface.

FIG. 8 depicts a print test performed using a photoreceptor drum having a 133 nm±25.6 nm (thickness and uniformity as measured by AFM) paraffin oil layer on its surface.

FIG. 9 depicts a print test performed using a photoreceptor drum having a 64.9 nm±12.9 nm (thickness and uniformity as measured by AFM) paraffin oil layer on its surface.

It should be noted that some details of the figures have been simplified and are drawn to facilitate understanding of the embodiments rather than to maintain strict structural accuracy, detail, and scale.

### DETAILED DESCRIPTION

An application member (e.g., a blade applicator) 35 is shown in FIG. 1. The application member is in a trailing position with respect to the surface of the photoreceptor 34. The term “photoreceptor” is generally used interchangeably with the phrase “imaging member.” The application member 35 can be held in the trailing position by a holding mechanism, such as bracket 31 and a clamp 33. The trailing position means the surface of the photoreceptor pulls the blade applicator 35 as the photoreceptor rotates. The clamp 33 can have saw tooth grooves to fix the application member 35 in place. The bracket 31 can be made of metal or plastic, and magnetically or mechanically attached to the housing of the photoreceptor. The application member 35 can be used to deliver/apply a surface control layer to the photoreceptor 34. The metering of a surface control layer material can be controlled by the contact pressure between the application member 35 and the surface of the photoreceptor 34.

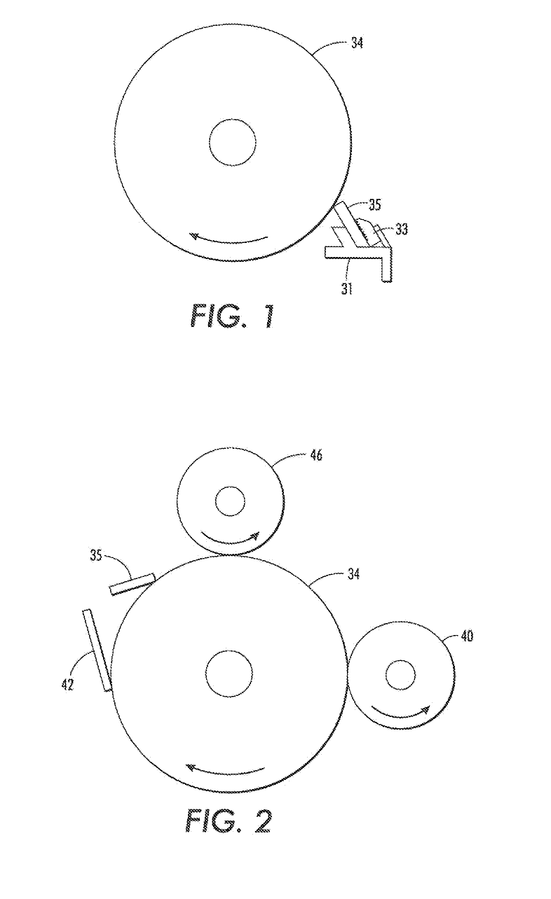

In FIG. 2, there is illustrated an image-forming apparatus having a BCR (bias charge roll) charging unit. As shown, the image-forming apparatus comprises a photoreceptor 34, a BCR 46 and an application member 35. The application member 35 contacts the photoreceptor 34 to deliver an ultra-thin layer of the surface control layer material/composition onto the surface of the photoreceptor 34. Subsequently, the photoreceptor 34 is substantially uniformly charged by the BCR 46 to initiate the electrophotographic reproduction process. The charged photoreceptor 34 can then be exposed to a light image to create an electrostatic latent image on the photoreceptive member (not shown). The latent image can subsequently be developed into a visible image by a toner developer 40. Thereafter, the developed toner image can be transferred from the photoreceptor 34 through a record medium to a copy sheet or some other image support substrate to which the image may be permanently affixed for producing a reproduction of the original document/image (not shown). The photoreceptor surface can be cleaned with a cleaner 42 to remove any residual developing material therefrom, in preparation for successive imaging cycles.

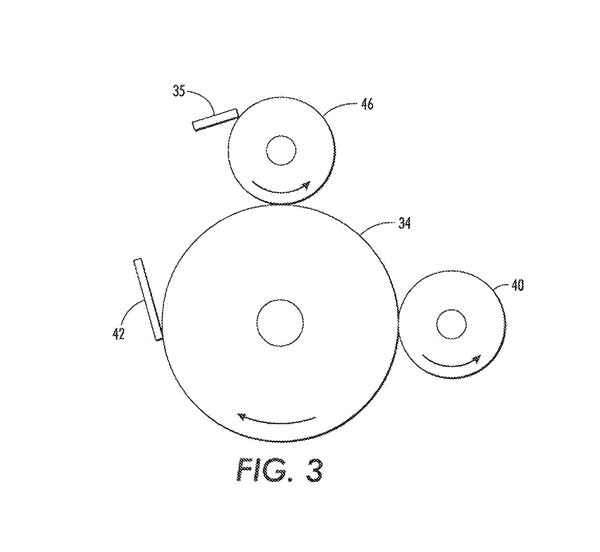

In FIG. 3, there is illustrated an alternate embodiment image-forming apparatus having a BCR charging unit. As shown, the image-forming apparatus comprises a photoreceptor 34, a BCR 46 and an application member 35. The application member 35 contacts the BCR 46, which in turn contacts the photoreceptor 34 to deliver a surface control layer onto the surface of the photoreceptor 34. The photoreceptor 34 is substantially uniformly charged by the BCR 46 to initiate the electrophotographic reproduction process. The charged photoreceptor can then be exposed to a light image to create an electrostatic latent image on the photoreceptive member (not shown). This latent image can subsequently be developed into a visible image by a toner developer 40. Thereafter, the developed toner image can be transferred from the photoreceptor member through a record medium to a copy sheet or some other image support substrate to which the image can be permanently affixed for producing a reproduction of the original document/image (not shown). The photoreceptor surface can then be cleaned with a cleaner 42 to remove any residual developing material therefrom in preparation for successive imaging cycles.

Certain embodiments are drawn to image forming apparatuses comprising: an imaging member, an application member, and optionally, a charging unit. The imaging member (e.g., photoreceptor) has a charge retentive surface for developing an electrostatic latent image thereon, and comprises a substrate, a photoconductive layer disposed on the substrate, and a surface control (SC) layer disposed on the outer surface of the imaging member. The surface control layer has a thickness of between about 5 nm and about 65 nm throughout the layer. In some embodiments, the SC layer can have a thickness between about 8 nm and about 65 nm throughout, between about 10 nm and about 65 nm throughout, between about 20 nm and about 65 nm throughout, or between about 30 nm and about 65 nm throughout. In embodiments the SC layer can have an average thickness between about 5 nm and about 65 nm with a deviation in thickness of no more than about 30% from the average thickness. A charging unit can apply an electrostatic charge on the imaging member and the application member can apply the SC layer to the surface of the imaging member.

Imaging members can have a configuration known in the art. The photoreceptor can have a number of different configurations, such as for example, a plate, a cylinder, a drum, a drelt (a cross between a drum and a belt), a scroll, an endless flexible belt, and the like. In the case of the photoreceptor being in the form of a belt, the belt can be seamed or seamless. In embodiments, the photoreceptor/imaging member herein can be in a drum configuration.

In embodiments the SC layer can comprise an alkane, a fluoroalkane, an alkyl silane, a fluoroalkyl silane, an alkoxy-silane, a siloxane, a glycol, a polyglycol, a mineral oil, a synthetic oil, a natural oil, or a mixture of two or more thereof. In some embodiments, the SC layer comprises a paraffin oil. In some embodiments the SC layer can comprise silicone oil.

In certain embodiments, the surface control layer can be in the form of a liquid, a wax, a gel, or a mixture of two or more thereof. The SC layer can be in the form of a liquid layer in some embodiments. In certain embodiments, the SC layer can be in a non-solid form (such as, a liquid, wax, or gel, among others), and can be distinguished from surface control systems comprising a solid powder lubricant known in the art.

The thickness of the SC layer throughout the layer (e.g., at any given point in the SC layer) can be between about 5 nm and about 60 nm, about 8 nm and about 60 nm, or about 15 nm and about 60 nm. In some embodiments, the SC layer can have a thickness between about 8 nm and about 65 nm throughout, between about 10 nm and about 65 nm throughout, between about 20 nm and about 65 nm throughout, or between about 30 nm and about 65 nm throughout. In embodiments, the average thickness of the SC layer can be between about 5 nm and about 60 nm, about 8 nm and about 60 nm, or about 15 nm and about 60 nm with a deviation in thickness of no more than about 30% from the average thickness in embodiments. In certain embodiments, the deviation in thickness is no more than about 25%, no more than about 20%, no more than about 15%, or no more than about 10% from the average thickness. Thus, the SC layer can be substantially uniform in thickness (e.g., a deviation in thickness of no more than about 30% from the average thickness).

In some embodiments, the application member used to apply the SC layer to the surface of the imaging member comprises a delivery roller or a blade applicator. Certain configurations for the application member (e.g., a blade applicator, among others) are shown in FIGS. 1-3.

In certain embodiments, images formed using the image forming apparatus can have little or no background darkening that is visible to the naked eye. In some embodiments, images formed using the image forming apparatus can have little or no streaking visible to the naked eye. In some embodiments, A-zone lateral charge migration (LCM) is reduced or prevented when forming an image with the image forming apparatus. In some embodiments, when a surface control layer (such as a layer of paraffin oil) has a thickness greater than about 65 nm the OD (measured optical density) can be about 0.062 for the background of an image, with a surface control layer having a thickness in the claimed range the OD for the background of an image can be about 0.048 and without a surface control layer, the OD can be about 0.046. In certain embodiments, using a surface control layer having an average thickness greater than about 65 nm can result in an increase of background density in an image of at least 30% (as measured by X-rite optical density meter).

Embodiments herein are also drawn to a surface control apparatus. The surface control (SC) apparatus can comprise an imaging member having a charge retentive surface for developing an electrostatic latent image thereon. The imaging member can comprise a substrate, a photoconductive layer disposed on the substrate, and a surface control (SC) layer disposed on the outer surface of the image imaging member. The SC layer can have a thickness of between about 5 nm and about 65 nm throughout. In some embodiments, the SC layer can have a thickness between about 8 nm and about 65 nm throughout, between about 10 nm and about 65 nm throughout, between about 20 nm and about 65 nm throughout, or between about 30 nm and about 65 nm throughout. In embodiments, the SC layer can have an average thickness of between about 5 nm and about 65 nm with a deviation in thickness of no more than about 30% from the average thickness. In certain embodiments, wherein the SC layer has an average thickness that is greater than 65 nm, a print can have an increase in background density of at least 30% (as measured by, for example, an X-rite optical density meter).

As discussed above, the SC layer can comprise an alkane, a fluoroalkane, an alkyl silane, a fluoroalkyl silane, an alkoxy-silane, a siloxane, a glycol, a polyglycol, a mineral oil, a synthetic oil, a natural oil, or a mixture of two or more thereof. In some embodiments, the SC apparatus comprises an SC layer that comprises a paraffin oil.

The SC layer of the SC apparatus can be in the form of a liquid, a wax, a gel, or a mixture of two or more thereof. In some embodiments the SC layer can be in the form of a liquid. In certain embodiments, the SC layer can be in a non-solid form (such as, a liquid, wax, or gel, among others), and can be distinguished from surface control systems comprising a solid powder surface control system known in the art.

In some embodiments, an image formed using an image forming apparatus having a surface control apparatus of embodiments herein installed has little or no background darkening visible to the naked eye and/or little or no streaking visible to the naked eye, or at least less background darkening or streaking than if a solid powder surface control system or a thick (e.g., greater that 65 nm) non-solid powder surface control system were used instead. In some embodiments, A-zone lateral charge migration (LCM) is prevent when forming an image with an image forming apparatus having the surface control apparatus installed therein.

Certain embodiments are drawn to methods for reducing printing defects by an image forming apparatus comprising an imaging member. The method can comprise applying to the outer surface of the imaging member a surface control (SC) layer at a thickness of between about 5 nm and about 65 nm throughout. In some embodiments, the SC layer can have a thickness between about 8 nm and about 65 nm throughout, between about 10 nm and about 65 nm throughout, between about 20 nm and about 65 nm throughout, or between about 30 nm and about 65 nm throughout. In some embodiments the SC layer can be applied at an average thickness between about 5 nm and about 65 nm with a deviation in thickness of no more than about 30% from the average thickness.

The SC layer can be as described above, and in certain embodiments the SC layer can comprise a paraffin oil. The average thickness of the SC layer can be as described above, for example, the thickness of the SC layer can be between about 8 nm and about 60 nm throughout, in some embodiments. In some embodiments, the SC layer can have a thickness between about 8 nm and about 65 nm throughout, between about 10 nm and about 65 nm throughout, between about 20 nm and about 65 nm throughout, or between about 30 nm and about 65 nm throughout. In certain embodiments, an image formed using methods herein can have little or no background darkening visible to the naked eye. In some embodiments, an image formed using methods herein can have little or no streaking visible to the naked eye. At least there can be less background darkening or streaking in embodiments than if a solid powder surface control system or a thick non-solid powder surface control system were used instead. In certain embodiments, A-zone lateral charge migration (LCM) is reduced or prevented when forming an image.

Unexpectedly, as demonstrated by examples discussed below, the average thickness and uniformity of a non-solid SCS layer (e.g., paraffin oil layer) affects certain problems associated with forming images. Embodiments can suppress background darkening and streaking phenomena associated with certain SCS technologies, such as, solid powder surface control systems or thick non-solid powder surface control systems.

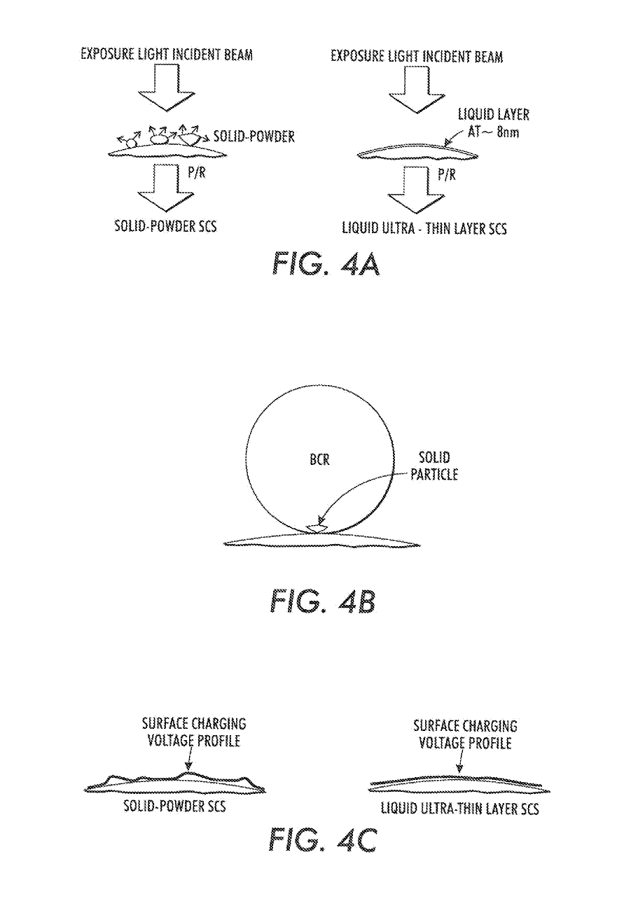

Externally applying surface control/functional materials onto the surface of a photoreceptor (PR) is known in the art. Solid powder lubricants/surface control systems applied to a PR using a brush-type roller have been developed to reduce friction and wear and increase PR lifetime. However, as discussed above, use of a solid powder surface control system has several shortcomings including that it is: a) very likely to scatter material and pollute neighboring components in the CRU (customer replaceable unit); b) difficult to control the thickness and uniformity of the surface coating to reduce friction uniformly and preserve image quality; c) likely that the brush applicator will locally abrade the PR after long-term running; and d) unavoidable that the small-size solid powder particles will cause abrasion on both the PR, bias charge roll and cleaning blade cutting edge. Furthermore, solid powder coatings can interfere with the optical path of the exposure light leading to light scattering or attenuation, causing image quality issues such as resolution loss and non-uniformities. (See FIG. 4.)

In contrast, certain embodiments herein comprise applying a layer (such as, an ultra-thin layer) of functional material (surface control layer material/composition that has a non-solid powder form, e.g., liquid form), such as paraffin oil, onto the PR surface. Embodiments herein can overcome certain problems associated with solid powder surface functional/control materials. In addition to providing lubrication and reducing wear, embodiments herein can eliminate A-zone lateral charge migration (LCM), prevent torque and blade chattering, and reduce toner/additive contamination, thereby producing a dramatic improvement in image quality (i.e., reduced background darkening and streaking), especially when the PR comprises a protective overcoat layer such as PASCO (polymeric anti-scratch overcoat).

FIG. 4 depicts the surface of a photoreceptor (PR) having a known solid powder surface control system (SCS) and a photoreceptor (PR) having a liquid SCS of embodiments herein. FIG. 4 a) illustrates the surface of a photoreceptor (PR) having a solid powder surface control system (SCS) known in the art and the surface of a photoreceptor having a liquid surface control system (SCS) as in embodiments herein. FIG. 4 b) depicts the surface of a photoreceptor having a solid powder SCS and a bias charge roll (BCR). FIG. 4 c) depicts the surface charging voltage profile at the surface of a photoreceptor (PR) having a solid powder SCS and at the surface of a photoreceptor having a liquid SCS (described below).

A non-solid powder, surface control layer, while providing great benefits to image quality, can also introduce unwanted background darkening and streaking within the image. Unexpectedly, the thickness and uniformity of the SCS liquid layer when kept within ranges disclosed herein can prevent unwanted streaking and background darkening. Examples below demonstrate that a SCS layer having an average thickness of about 60 nm or less and a thickness uniformity of no more than about 30% deviation from the average thickness produces excellent image quality free of or with reduced background darkening and streaking associated, while maintaining LCM (lateral charge migration) prevention, torque reduction, and toner/additive contamination reduction. The thickness and uniformity was characterized using AFM techniques in the examples.

Some embodiments are drawn to imaging members comprising: a support, and a photoconductive layer disposed on the support with optional additional layers. The photoconductive layer can have a multi-layered structure that comprises a charge generation layer disposed on the support and a charge transport layer disposed on the charge generation layer. Alternatively, the photoconductive layer can have a single layer structure, as known in the art.

In certain embodiments, an imaging member can have a belt configuration. The belt configuration can be provided with an anti-curl back coating, a support/substrate, an electrically conductive ground plane, an undercoat layer, an adhesive layer, a charge generation layer, a charge transport layer, and/or an overcoat/outer layer, among others known in the art. In some embodiments, the imaging layer can be multilayered and can comprise the electrically conductive ground plane, the undercoat layer, the adhesive layer, and the charge generation layer. An exemplary photoreceptor having a belt configuration is disclosed in U.S. Pat. No. 5,069,993, the entire disclosure thereof being incorporated herein by reference.

Certain embodiments are drawn to photoreceptors/imaging members that include an outer layer over a photoconductive layer. In embodiments, the outer layer can be a polymeric overcoat or PASCO (polymeric anti-scratch overcoat) layer. The outer layer can be disposed over a layer comprising a charge transport component or the outer layer itself can comprise a charge transport component.

In embodiments, the outer layer can include thermoplastic organic polymers or inorganic polymers that are electrically insulating or slightly semi-conductive. For example, a outer layer can include a suitable resin selected from polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloridelvinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. The outer layer can be continuous and have a thickness of between about 0.5 micron and about 10 microns, between about 0.5 micron and about 2 microns, or between about 0.5 micron and about 6 microns.

In some embodiments, the outer layer can include a charge transport component and, optionally, organic polymers or inorganic polymers. In certain embodiments, a charge transport component can be a component of the imaging member/photoreceptor without being a component of the outer layer overcoat. In some embodiments, the outer layer/overcoat comprises a charge transport component and, optionally, another layer of the imaging member/photoreceptor also comprises a charge transport component.

The polymeric overcoat or PASCO layer can be prepared using formulations known in the art for overcoating a photoreceptor. In some embodiments, a PASCO overcoating layer formulation can comprise a hydroxyl-containing charge transport molecule, a polyol polymer binder, and a melamine-based curing agent, which, upon thermal curing, can form a crosslinked overcoat/outer layer.

In some embodiments the outer layer can be prepared with a curable composition comprising a charge transport component and a curing agent and the outer layer comprises the cross-linked product. The transport component can comprise a tertiary amine having at least one curable functional group selected from the group consisting of a hydroxyl, a hydroxylmethyl, an alkoxymethyl, a hydroxyalkyl having from 1 to 15 carbons, an acrylate and mixtures of two or more thereof. The alkoxymethyl can be —CH₂OR, wherein R can be an alkyl having from about 1 to about 10 carbons or from about 1 to about 5 carbons, and the hydroxylalkyl can have about 1 to about 10 carbons, or from about 1 to about 5 carbons. The curing agent can be selected from the group consisting of melamine-formaldehyde resin, a phenol resin, an isocyalate or a masking isocyalate compound, an acrylate resin, a polyol resin, and mixtures of two or more thereof.

In embodiments, the outer layer can include a charge transport component. In particular embodiments, the outer layer comprises a charge transport component comprised of a tertiary arylamine containing a substituent capable of self cross-linking or reacting with the polymer resin to form cured composition. Specific examples of charge transport components suitable for the outer layer comprise a tertiary arylamine with a general formula of

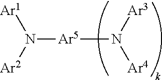

wherein Ar¹, A², Ar³, and Ar⁴ each independently represents an aryl group having from about 4 to about 10 carbon atoms, or from about 5 to about 10 carbons, or from about 6 to about 10 carbons and Ar⁵ represents aromatic hydrocarbon group having about 4 to about 10 carbon atoms, or from about 5 to about 10 carbons, or from about 6 to about 10 carbons and k represents 0 or 1, and wherein at least one of Ar¹, Ar², Ar³, Ar⁴, and Ar⁵ comprises a substituent selected from the group consisting of hydroxyl (—OH), a hydroxymethyl (—CH₂OH), an alkoxymethyl (—CH₂OR, wherein R can be an alkyl having from about 1 to about 10 carbons or from about 1 to about 5 carbons), a hydroxylalkyl having about 1 to about 10 carbons, or from about 1 to about 5 carbons and mixtures thereof. In other embodiments, Ar¹, Ar², Ar³, and Ar⁴ each independently represent a phenyl or a substituted phenyl group, and Ar⁵ represents a biphenyl or a terphenyl group.

In specific embodiments, the charge or hole transport molecule can be selected from the group consisting of N,N′-diphenyl-N,N′-bis(hydroxyphenyl)-[1,1′-terphenyl]-4,4′-diamine, and N,N′-diphenyl-N,N′-bis(3-hydroxyphenyl)-[1,1′-biphenyl]-4,4′-diamine, and mixtures thereof. In certain embodiments, the charge transport component comprises a tertiary arylamine selected from the group consisting of N,N′-diphenyl-N,N′-bis(3-methylphenyl)-(1,1′-biphenyl)-4,4′-diamine, N,N′-diphenyl-N,N′-bis(4-methylphenyl)-(1,1′-biphenyl)-4,4′-diamine, N,N,N′,N′-tetrakis(4-methylphenyl)-1,1′-biphenyl)-4,4′-diamine, N,N′-bis(4-butylphenyl)-N,N′-di-p-tolyl-[p-terphenyl]-4,4′-diamine, and N,N′-bis(4-butylphenyl)-N,N′-di-m-tolyl-[p-terphenyl]-4,4′-diamine, and mixtures thereof.

In some embodiments, the outer layer can also include a crosslinking agent, an optional resin and/or one or more optional surface additives. In such embodiments, the crosslinking agent can comprise methylated formaldehyde-melamine resin, imethoxymethylated melamine resin, ethoxymethylated melamine resin, propoxymethylated melamine resin, butoxymethylated melamine resin, hexamethylol melamine resin, alkoxyalkylated melamine resins, or mixtures thereof. In such embodiments, the resin can comprise an acrylic polyol, a polyesterpolyol, a polyacrylatepolyol, or a mixture thereof. In such embodiments, the one or more surface additives can comprise a silicone modified polyacrylate, an alkylsilane, a perfluorinated alkylalcohol, or a mixture thereof.

Any suitable and conventional technique can be utilized to form and thereafter apply the outer layer formulation to the photoconductive layer/photosensitive substrate. The outer layer/overcoat can be formed in a single coating step or in multiple coating steps. Dip coating, ring coating, spray, gravure or any other drum coating methods can be used. Drying of the deposited formulation can be effected by any suitable conventional technique such as oven drying, infra red radiation drying, air drying and the like.

In specific embodiments, there can be provided an imaging member such that, positioned in between a support and the outer layer, there can be positioned a charge generation layer (e.g., as a layer of a multilayered photoconductive layer) comprising a metal free phthalocyanine, a titanyl phthalocyanine, a chlorogallium phthalocyanine, a hydroxygallium phthalocyanine, or a mixture of alkylhydroxy gallium phthalocyanine and hydroxygallium phthalocyanine, or a perylene, or mixture thereof.

The photoreceptor support can be opaque or substantially transparent, and can comprise any suitable organic or inorganic material having the requisite mechanical properties. The entire support can comprise the same material as that in the electrically conductive surface, or the electrically conductive surface can be merely a coating on the support/substrate. Any suitable electrically conductive material can be employed, such as for example, metal or metal alloy. Electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, nickel, niobium, stainless steel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It can be a single metallic compound or dual layers of different metals and/or oxides.

The support can also be formulated entirely of an electrically conductive material, or it can be an insulating material including inorganic or organic polymeric materials, such as MYLAR®, a commercially available biaxially oriented polyethylene terephthalate from DuPont, or polyethylene naphthalate available as KALADEX® 2000, with a ground plane layer comprising a conductive titanium or titanium/zirconium coating, otherwise a layer of an organic or inorganic material having a semiconductive surface layer, such as indium tin oxide, aluminum, titanium, and the like, or exclusively be made up of a conductive material such as, aluminum, chromium, nickel, brass, other metals and the like. The thickness of the support depends on numerous factors, including mechanical performance and economic considerations. The thickness of the support of the present embodiments can be at least about 500 microns, or no more than about 3000 microns, or be at least about 750 microns, or no more than about 2500 microns.

The electrically conductive ground plane can be an electrically conductive metal layer which can be formed, for example, on the support by any suitable coating technique, such as a vacuum depositing technique. Metals include aluminum, zirconium, niobium, tantalum, vanadium, hafnium, titanium, nickel, stainless steel, chromium, tungsten, molybdenum, and other conductive substances, and mixtures thereof. The conductive layer can vary in thickness over substantially wide ranges depending on the optical transparency and flexibility desired for the electrophotoconductive member. Accordingly, for a flexible photoresponsive imaging device, the thickness of the conductive layer can be at least about 20 Angstroms, or no more than about 750 Angstroms, or at least about 50 Angstroms, or no more than about 200 Angstroms for an optimum combination of electrical conductivity, flexibility and light transmission.

Regardless of the technique employed to form the metal layer, a thin layer of metal oxide forms on the outer surface of most metals upon exposure to air. Thus, when other layers overlying the metal layer are characterized as “contiguous” layers, it can be that these overlying contiguous layers can, in fact, contact a thin metal oxide layer that has formed on the outer surface of the oxidizable metal layer. For rear erase exposure, a conductive layer light transparency of at least about 15 percent can be desirable. The conductive layer need not be limited to metals. Other examples of conductive layers can be combinations of materials such as conductive indium tin oxide as transparent layer for light having a wavelength between about 4000 Angstroms and about 9000 Angstroms or a conductive carbon black dispersed in a polymeric binder as an opaque conductive layer.

After deposition of the electrically conductive ground plane layer, a hole blocking layer can be applied thereto. Electron blocking layers for positively charged photoreceptors allow holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer can be utilized. The hole blocking layer can include polymers such as polyvinylbutryral, epoxy resins, polyesters, polysiloxanes, polyamides, polyurethanes and the like, or can be nitrogen containing siloxanes or nitrogen containing titanium compounds such as trimethoxysilyl propylene diamine, hydrolyzed trimethoxysilyl propyl ethylene diamine, N-beta-(aminoethyl) gamma-amino-propyl trimethoxy silane, isopropyl 4-aminobenzene sulfonyl, di(dodecylbenzene sulfonyl) titanate, isopropyl di(4-aminobenzoyl)isostearoyl titanate, isopropyl tri(N-ethylamino-ethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, [H₂N(CH₂)₄]CH₃Si(OCH₃)₂, (gamma-aminobutyl) methyl diethoxysilane, and [H₂N(CH₂)₄]CH₃Si(OCH₃)₂, (gamma-aminopropyl) methyl diethoxysilane, as disclosed in U.S. Pat. Nos. 4,338,387, 4,286,033 and 4,291,110, the contents of which are incorporated herein by reference in their entirety.

General embodiments of the undercoat layer can comprise a metal oxide and a resin binder. The metal oxides that can be used with the embodiments herein include, but are not limited to, titanium oxide, zinc oxide, tin oxide, aluminum oxide, silicon oxide, zirconium oxide, indium oxide, molybdenum oxide, and mixtures thereof. Undercoat layer binder materials can include, for example, polyesters, MOR-ESTER® 49,000 from Morton International Inc., VITEL® PE-100, VITEL® PE-200, VITEL® PE-200D, and VITEL® PE-222 from Goodyear Tire and Rubber Co., polyarylates such as ARDEL™ from AMOCO Production Products, polysulfone from AMOCO Production Products, polyurethanes, and the like.

The hole blocking layer can be continuous and have a thickness of less than about 0.5 micron because greater thicknesses can lead to undesirably high residual voltage. A hole blocking layer of between about 0.005 micron and about 0.3 micron can be used because charge neutralization after the exposure step can be facilitated and optimum electrical performance can be achieved. A thickness of between about 0.03 micron and about 0.06 micron can be used for hole blocking layers for optimum electrical behavior. The blocking layer can be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layer can be applied in the form of a dilute solution, with the solvent being removed after deposition of the coating by conventional techniques such as by vacuum, heating and the like. A weight ratio of hole blocking layer material and solvent of between about 0.05:100 to about 0.5:100 can be satisfactory for spray coating.

A charge generation layer can thereafter be applied to the undercoat layer. Any suitable charge generation binder including a charge generation photoconductive material, which can be in the form of particles and dispersed in a film forming binder, such as an inactive resin, can be utilized. Examples of charge generation materials include, for example, inorganic photoconductive materials such as amorphous selenium, trigonal selenium, and selenium alloys selected from the group consisting of selenium-tellurium, selenium-tellurium-arsenic; selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like, and mixtures thereof, dispersed in a film forming polymeric binder. Selenium, selenium alloy, benzimidazole perylene, and the like and mixtures thereof can be formed as a continuous, homogeneous charge generation layer. Benzimidazole perylene compositions are well known and described, for example, in U.S. Pat. No. 4,587,189, the entire disclosure thereof being incorporated herein by reference. Multi-charge generation layer compositions can be used where a photoconductive layer enhances or reduces the properties of the charge generation layer. Other suitable charge generation materials known in the art can also be utilized, if desired. The charge generation materials selected can be sensitive to activating radiation having a wavelength between about 400 and about 900 nm during the imagewise radiation exposure step in an electrophotographic imaging process to form an electrostatic latent image. For example, hydroxygallium phthalocyanine absorbs light of a wavelength of from about 370 to about 950 nanometers, as disclosed, for example, in U.S. Pat. No. 5,756,245, the entire disclosure thereof being incorporated herein by reference.

Any suitable inactive resin materials can be employed as a binder in the charge generation layer, including those described, for example, in U.S. Pat. No. 3,121,006, the entire disclosure thereof being incorporated herein by reference. Organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder can be PCZ-400 (poly(4,4′-dihydroxy-diphenyl-1-1-cyclohexane) which has a viscosity-molecular weight of 40,000 and is available from Mitsubishi Gas Chemical Corporation (Tokyo, Japan).

The charge generation material can be present in the resinous binder composition in various amounts. At least about 5 percent by volume or no more than about 90 percent by volume of the charge generation material can be dispersed in at least about 95 percent by volume, or no more than about 10 percent by volume of the resinous binder, and more specifically at least about 20 percent, or no more than about 60 percent by volume of the charge generation material can be dispersed in at least about 80 percent by volume, or no more than about 40 percent by volume of the resinous binder composition.

In specific embodiments, the charge generation layer can have a thickness of at least about 0.1 μm, or no more than about 2 μm, or of at least about 0.2 μm, or no more than about 1 μm. These embodiments can be comprised of chlorogallium phthalocyanine or hydroxygallium phthalocyanine or mixtures thereof. The charge generation layer containing the charge generation material and the resinous binder material can have a thickness of at least about 0.1 μm, or no more than about 5 μm, for example, from about 0.2 μm to about 3 μm when dry. The charge generation layer thickness can be related to binder content. Higher binder content compositions can employ thicker layers for charge generation.

In a drum photoreceptor, the charge transport layer can comprise a single layer of the same composition. As such, the charge transport layer will be discussed specifically in terms of a single layer, but the details will be also applicable to an embodiment having dual charge transport layers. The charge transport layer can thereafter be applied over the charge generation layer and can include any suitable transparent organic polymer or non-polymeric material capable of supporting the injection of photogenerated holes or electrons from the charge generation layer and capable of allowing the transport of these holes/electrons through the charge transport layer to selectively discharge the surface charge on the imaging member surface. In one embodiment, the charge transport layer not only serves to transport holes, but also protects the charge generation layer from abrasion or chemical attack and can therefore extend the service life of the imaging member. The charge transport layer can be a substantially non-photoconductive material, but one which supports the injection of photogenerated holes from the charge generation layer.

The layer can be transparent in a wavelength region in which the electrophotographic imaging member can be used when exposure can be affected there to ensure that most of the incident radiation can be utilized by the underlying charge generation layer. The charge transport layer can exhibit excellent optical transparency with negligible light absorption and no charge generation when exposed to a wavelength of light useful in xerography, e.g., 400 to 900 nanometers. In the case when the photoreceptor can be prepared with the use of a transparent support and also a transparent or partially transparent conductive layer, image wise exposure or erase can be accomplished through the support with all light passing through the back side of the support. In this case, the materials of the layer need not transmit light in the wavelength region of use if the charge generation layer can be sandwiched between the support and the charge transport layer. The charge transport layer in conjunction with the charge generation layer can be an insulator to the extent that an electrostatic charge placed on the charge transport layer is not conducted in the absence of illumination. The charge transport layer can trap minimal charges as the charge passes through it during the discharging process.

The charge transport layer can include any suitable charge transport component or activating compound useful as an additive dissolved or molecularly dispersed in an electrically inactive polymeric material, such as a polycarbonate binder, to form a solid solution and thereby making this material electrically active. “Dissolved” refers, for example, to forming a solution in which the small molecule can be dissolved in the polymer to form a homogeneous phase; and molecularly dispersed in embodiments refers, for example, to charge transporting molecules dispersed in the polymer, the small molecules being dispersed in the polymer on a molecular scale. The charge transport component can be added to a film forming polymeric material which can otherwise be incapable of supporting the injection of photogenerated holes from the charge generation material and incapable of allowing the transport of these holes through. This addition converts the electrically inactive polymeric material to a material capable of supporting the injection of photogenerated holes from the charge generation layer and capable of allowing the transport of these holes through the charge transport layer in order to discharge the surface charge on the charge transport layer. The high mobility charge transport component can comprise small molecules of an organic compound which cooperate to transport charge between molecules and ultimately to the surface of the charge transport layer. For example, but not limited to, N,N′-diphenyl-N,N-bis(3-methyl phenyl)-1,1′-biphenyl-4,4′-diamine (TPD), other arylamines like triphenyl amine, N,N,N′,N′-tetra-p-tolyl-1,1′-biphenyl-4,4′-diamine (TM-TPD), and the like.

A number of charge transport compounds can be included in the charge transport layer, which layer can have of a thickness of from about 5 to about 75 microns, and more specifically, of a thickness of from about 15 to about 40 microns. Charge transport components can be aryl amines known in the art.

Examples of specific aryl amines that can be selected for the charge transport layer include N,N′-diphenyl-N,N′-bis(alkylphenyl)-1,1-biphenyl-4,4′-diamine wherein alkyl can be selected from the group consisting of methyl, ethyl, propyl, butyl, hexyl, and the like; N,N′-diphenyl-N,N′-bis(halophenyl)-1,1′-biphenyl-4,4′-diamine wherein the halo substituent can be a chloro substituent; N,N′-bis(4-butylphenyl)-N,N′-di-p-tolyl-[p-terphenyl]-4,4′-diamine, N,N′-bis(4-butylphenyl)-N,N′-di-m-tolyl-[p-terphenyl]-4,4′-diamine, N,N′-bis(4-butylphenyl)-N,N′-di-o-tolyl-[p-terphenyl]-4,4′-diamine, N,N′-bis(4-butylphenyl)-N,N′-bis-(4-isopropylphenyl)-[p-terphenyl]-4,4′-diamine, N,N′-bis(4-butylphenyl)-N,N′-bis-(2-ethyl-6-methylphenyl)-[p-terphenyl]-4,4′-diamine, N,N′-bis{4-butylphenyl)-N,N′-bis-(2,5-dimethylphenyl)-[p-terphenyl]-4,4′-diamine, N,N′-diphenyl-N,N′-bis(3-chlorophenyl)-[p-terphenyl]-4,4′-diamine, and the like. Other known charge transport layer molecules can be selected in embodiments, reference for example, U.S. Pat. Nos. 4,921,773 and 4,464,450, the disclosures of which are incorporated herein by reference in their entirety.

Examples of the binder materials selected for the charge transport layers include components, such as those described in U.S. Pat. No. 3,121,006, the disclosure of which is incorporated herein by reference in its entirety. Specific examples of polymer binder materials include polycarbonates, polyarylates, acrylate polymers, vinyl polymers, cellulose polymers, polyesters, polysiloxanes, polyamides, polyurethanes, poly(cyclo olefins), and epoxies, and random or alternating copolymers thereof. In embodiments, the charge transport layer, such as a hole transport layer, can have a thickness of at least about 10 μm, or no more than about 40 μm.

Examples of components or materials optionally incorporated into the charge transport layers or at least one charge transport layer to, for example, enable improved lateral charge migration (LCM) resistance include hindered phenolic antioxidants such as tetrakis methylene(3,5-di-tert-butyl-4-hydroxy hydrocinnamate) methane (IRGANOX® 1010, available from Ciba Specialty Chemical), butylated hydroxytoluene (BHT), and other hindered phenolic antioxidants including SUMILIZER™ BHT-R, MDP-S, BBM-S, WX-R. NW, BP-76, BP-101, GA-80, GM and GS (available from Sumitomo Chemical Co., Ltd.), IRGANOX® 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANO™ LS-2626, LS-765, LS-770 and LS-744 (available from SANKYO CO., Ltd.), TINUVIN® 144 and 622LD (available from Ciba Specialties Chemicals), MARK™ LA57, LA67, LA62, LA68 and LA63 (available from Asahi Denka Co., Ltd.), and SUMILIZER® TPS (available from Sumitomo Chemical Co., Ltd.); thioether antioxidants such as SUMILIZER® TP-D (available from Sumitomo Chemical Co., Ltd.); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl) phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layers can be from about 0 to about 20, from about 1 to about 10, or from about 3 to about 8 weight percent.

The charge transport layer can be an insulator to the extent that the electrostatic charge placed on the hole transport layer is not conducted in the absence of illumination at a rate sufficient to prevent formation and retention of an electrostatic latent image thereon. The charge transport layer can be substantially nonabsorbing to visible light or radiation in the region of intended use, but can be electrically “active” in that it allows the injection of photogenerated holes from the photoconductive layer, that can be the charge generation layer, and allows these holes to be transported through itself to selectively discharge a surface charge on the surface of the active layer.

In addition, in the present embodiments using a belt configuration, the charge transport layer can consist of a single pass charge transport layer or a dual pass charge transport layer (or dual layer charge transport layer) with the same or different transport molecule ratios. In these embodiments, the dual layer charge transport layer has a total thickness of from about 10 μm to about 40 μm. In other embodiments, each layer of the dual layer charge transport layer can have an individual thickness of from about 2 μm to about 20 μm. Moreover, the charge transport layer can be configured such that it can be used as a top layer of the photoreceptor to inhibit crystallization at the interface of the charge transport layer and the outer layer. In another embodiment, the charge transport layer can be configured such that it can be used as a first pass charge transport layer to inhibit microcrystallization occurring at the interface between the first pass and second pass layers.

An optional adhesive interface layer can be provided in certain configurations, such as for example, in flexible web configurations. An interface layer can be situated between a blocking layer and a charge generation layer, in certain web configurations. The interface layer can include a copolyester resin. Exemplary polyester resins which can be utilized for the interface layer include polyarylatepolyvinylbutyrals, such as ARDEL POLYARYLATE (U-100) commercially available from Toyota Hsutsu Inc., VITEL® PE-100, VITEL® PE-200, VITEL® PE-200D, and VITEL® PE-222, all from Bostik, 49,000 polyester from Rohm Hass, polyvinyl butyral, and the like. The adhesive interface layer can be applied directly to a hole blocking layer. Thus, the adhesive interface layer in embodiments can be in direct contiguous contact with both a underlying hole blocking layer and an overlying charge generation layer to enhance adhesion bonding to provide linkage. In yet other embodiments, the adhesive interface layer can be entirely omitted.

Any suitable solvent or solvent mixtures can be employed to form a coating solution of a polyester for the adhesive interface layer. Solvents can include tetrahydrofuran, toluene, monochlorbenzene, methylene chloride, cyclohexanone, and the like, and mixtures thereof. Any other suitable and conventional technique can be used to mix and thereafter apply the adhesive layer coating mixture to the hole blocking layer. Application techniques can include spraying, dip coating, roll coating, wire wound rod coating, and the like. Drying of the deposited wet coating can be effected by any suitable conventional process, such as oven drying, infra red radiation drying, air drying, and the like.

The adhesive interface layer can have a thickness of at least about 0.01 microns, or no more than about 900 microns after drying. In embodiments, the dried thickness can be from about 0.03 microns to about 1 microns.

The ground plane can comprise a film forming polymer binder and electrically conductive particles. Any suitable electrically conductive particles can be used in the electrically conductive ground plane layer. The ground plane can comprise materials which include those enumerated in U.S. Pat. No. 4,664,995, the entire disclosure thereof being incorporated herein by reference. Electrically conductive particles include carbon black, graphite, copper, silver, gold, nickel, tantalum, chromium, zirconium, vanadium, niobium, indium, tin oxide and the like. The electrically conductive particles can have any suitable shape. Shapes can include irregular, granular, spherical, elliptical, cubic, flake, filament, and the like. The electrically conductive particles can have a particle size less than the thickness of the electrically conductive ground plane layer to avoid an electrically conductive ground plane layer having an excessively irregular outer surface. An average particle size of less than about 10 microns can avoid excessive protrusion of the electrically conductive particles at the outer surface of the dried ground plane layer and ensures relatively uniform dispersion of the particles throughout the matrix of the dried ground plane layer. The concentration of the conductive particles to be used in the ground plane depends on factors such as the conductivity of the specific conductive particles utilized. The ground plane layer can have a thickness of at least about 7 microns, or no more than about 42 microns, or of at least about 14 microns, or no more than about 27 microns.

An anti-curl back coating can comprise organic polymers or inorganic polymers that are electrically insulating or slightly semi-conductive. The anti-curl back coating provides flatness and/or abrasion resistance.

Anti-curl back coating can be formed at the back side of the support, opposite to the imaging layer. The anti-curl back coating can comprise a film forming resin binder and an adhesion promoter additive. The resin binder can include the same resins as the resin binders of the charge transport layer discussed above. Examples of film forming resins include polyacrylate, polystyrene, bisphenol polycarbonate, poly(4,4′-isopropylidene diphenyl carbonate), 4,4′-cyclohexylidene diphenyl polycarbonate, and the like. Adhesion promoters used as additives include 49,000 (du Pont), VITEL® PE-100, VITEL® PE-200, VITEL® PE-307 (Goodyear), and the like. Usually from about 1 to about 15 weight percent adhesion promoter can be selected for film forming resin addition. The thickness of the anti-curl back coating can be at least about 3 microns, or no more than about 35 microns, or about 14 microns.

The following Examples further define and describe embodiments herein. Unless otherwise indicated, all parts and percentages are by weight.

### EXAMPLES

The following examples demonstrate that controlling the thickness and uniformity of an surface control system (SCS) layer can be used to suppress background darkening and streaking issues associated with image production. An SCS layer (paraffin oil layer) was deposited onto the surface of a photoreceptor and then measured for thickness and uniformity using a commercially available atomic force microscopy (AFM) system (Solver_Pro 7 from NT-MDT Co.). The SCS was fully integrated into an Oakmont printer and tested with multiple examples.

Sample Preparation and Evaluation Procedures

Photoreceptor Fabrication

A coating solution for an undercoat layer containing 100 parts by weight a zirconium compound (trade name: ORGATIX ZC540, (acetylacetonate tributoxy zirconium) Matsumoto Fine Chemical Co., Ltd.), 10 parts by weight a silane compound (trade name: A110 manufactured by Nippon Unicar Co., Ltd), 400 parts by weight isopropanol and 200 parts by weight butanol was prepared. The coating solution was applied to a 30-mm diameter cylindrical aluminum (AI) substrate subjected to honing treatment by dip coating, and dried by heating at 150° C. for 10 minutes to form an undercoat layer having a film thickness of 0.1 micron.

A 0.5 micron thick charge generation layer was subsequently dip coated on top of the undercoat layer from a dispersion of Type V hydroxygallium phthalocyanine (12 parts by weight), alkylhydroxy gallium phthalocyanine (3 parts by weight), and a vinyl chloride/vinyl acetate copolymer (VMCH) (10 parts by weight) available from Dow Chemical (Mₙ=27,000, about 86 weight percent of vinyl chloride, about 13 weight percent of vinyl acetate and about 1 weight percent of maleic acid), in 475 parts by weight of n-butylacetate.

Subsequently, a 20 micron thick charge transport layer (CTL) was dip coated on top of the charge generation layer employing a solution containing N,N′-diphenyl-N,N′-bis(3-methylphenyl)-1,1′-biphenyl-4,4′-diamine (82.3 parts by weight), 2,6-di-tert-butyl-4-methylphenol (BHT) (2.1 parts by weight) from Aldrich and a polycarbonate, PCZ-400 poly(4,4′-dihydroxy-diphenyl-1-1-cyclohexane) (123.5 parts by weight), Mw=40,000 available from Mitsubishi Gas Chemical Company, Ltd. in a mixture of tetrahydrofuran (THF) (546 parts by weight) and monochlorobenzene (234 parts by weight). The CTL was dried at 115° C. for 60 minutes.

An overcoat coating solution was prepared from a mixture of N,N,N′,N′-tetrakis-[(4-hydroxymethyl)phenyl]-biphenyl-4,4′-diamine (3.22 parts by weight), N,N-diphenyl-N,N′-bis-(3-hydroxyphenyl)-biphenyl-4,4′-diamine (7.98 parts by weight), melamine-formaldehyde resin (2.10 parts by weight), a silicone leveling agent (0.5 parts by weight), an anti-oxidant (0.4 parts by weight), and an acid catalyst (0.65 parts by weight) in a solvent of 1-methoxy-2-propanol (40.3 parts by weight). The mixture was mixed on a rolling wave rotator for 10 minutes and then heated at 50° C. for 65 min until a homogenous solution resulted, then cooled to room temperature. After filtering with a 1-micron PTFE (polytetrafluoroethylene) filter, the solution was applied to the photoreceptor surface and more specifically, onto the charge transport layer using a cup coating technique, followed by thermal curing at 155° C. for 40 minutes to form an overcoat layer having a film thickness of 6 micron.

Surface Control System (SCS) Delivery Roller Fabrication

A crosslinkable polydimethylsiloxane (PDMS) base and curing agent (SYLGARD® 184 (silicone elastomer), Dow Corning) were mixed together in a 10:1 ratio by mass. The components were stirred together. To this mixture was added paraffin oil in a ratio of 4:1 PDMS to paraffin oil. The mixture was stirred together until a viscous mixture was obtained. The mixture was injected into a cylindrical mold, and degassed for one hour. The remaining mold was assembled and the PDMS:paraffin mixture was cured in a forced air lab oven at 60° C. for three hours. The delivery roller was extracted from the mold and incorporated into a customer replaceable unit (CRU) for print testing.

Application of SCS to Photoreceptor Surface

To enable easy variation in SCS layer thickness a single layer delivery roller design was used for experiments. This design was prone to leakage and buildup of paraffin oil when left idle for extended periods of time. The magnitude of paraffin buildup on the surface was dependent on the idle time. By varying the idle time before physical application (1 rotation) of the roller on the photorecepter, the thickness and uniformity of the surface control system layer was varied accordingly.

Sample Evaluation Procedures

Atomic Force Microscopy (AFM) Characterization

A commercially available AFM system (Solver P47H-PRO from NT-MDT Co.) was used to measure the targeted physical properties. A force-distance curve mapping technique was applied to characterize the thickness and uniformity of the applied oil layer (SCS layer).

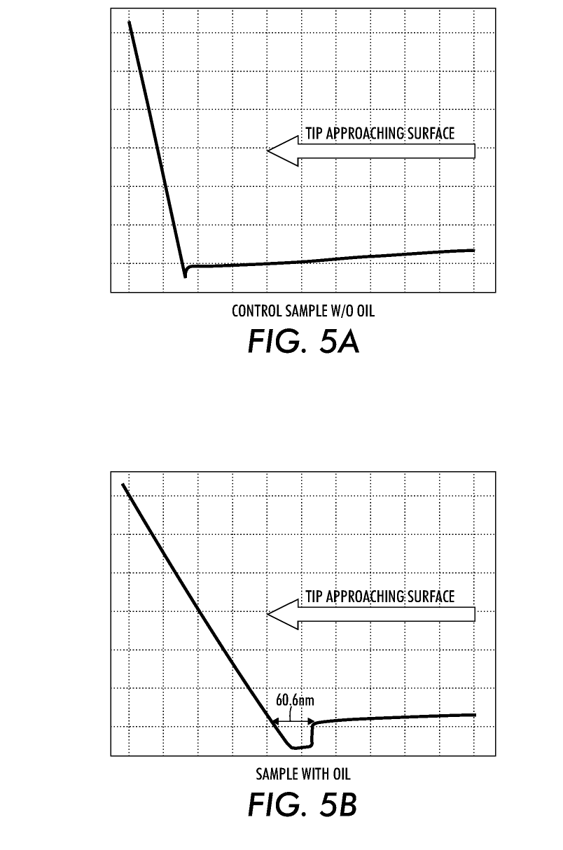

A typical force-distance curve on a control sample without oil was different from a sample with oil applied as shown in FIG. 5. The experimental parameters to characterize the thickness of the oil layer (SCS layer) using AFM were:
Randomly choose a scanning area with a size of 30 μm×30 μm and randomly pick up 100 points to do force curve, and
Repeat step a on five different positions with a total of 500 points being captured for a sample.

Print Testing

A Xerox Oakmont CRU (customer replaceable unit) was modified by replacing the BCR (bias charge roll) foam cleaner with the delivery member as fabricated, and placing an overcoated photoreceptor as fabricated above. The good conformal contact between the delivery roll and BCR was examined to ensure smooth rotation. In this manner, the delivery roller applied first a thin layer of paraffin onto the BCR roll, which in returns applied the paraffin onto the surface of the photoreceptor as it rotated. The absence of a cleaning blade enabled the thickness to be varied by the number of rotations on the photoreceptor. It should be noted that this method for varying thickness of the SCS layer (surface control system layer) was used to enable variable thickness of SCS layers for testing. In a commercially available machine with a cleaning blade the thickness of the SCS layer will depend on the intrinsic delivery rate of oil to the photoreceptor surface under various conditions.

### Comparative Example 1

A very thick SCS coating of paraffin oil was applied over the entire surface of a photoreceptor drum. The thickness of paraffin oil layer was outside of the AFM measurement capability, putting it in the microns range.

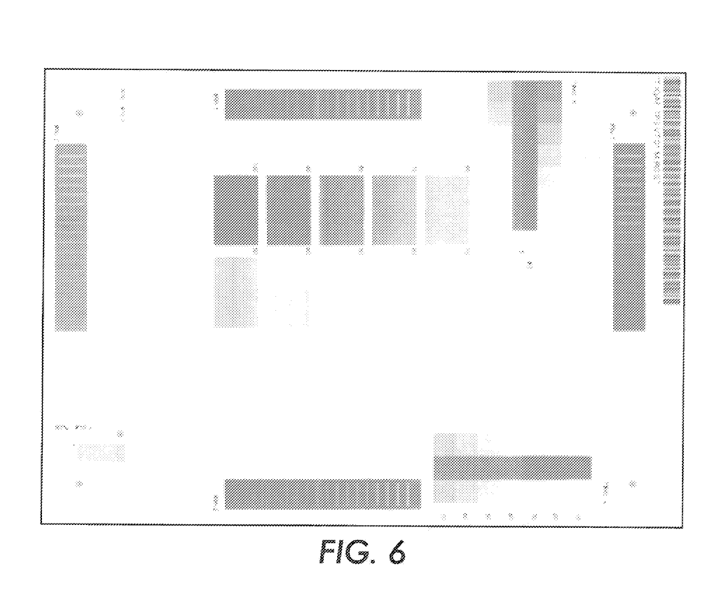

As can be seen from FIG. 6, the resulting print test showed severe streaking and image loss. Not to be bound by theory, it appeared that the SCS layer was too thick and caused interference with toner transfer.

### Example 1

An ultra thin SCS coating of paraffin oil was applied over a photoreceptor drum surface. Using atomic force microscopy (AFM) the thickness and uniformity of the SCS layer (paraffin oil layer) was measured to be 8.2 nm±1.5 nm.

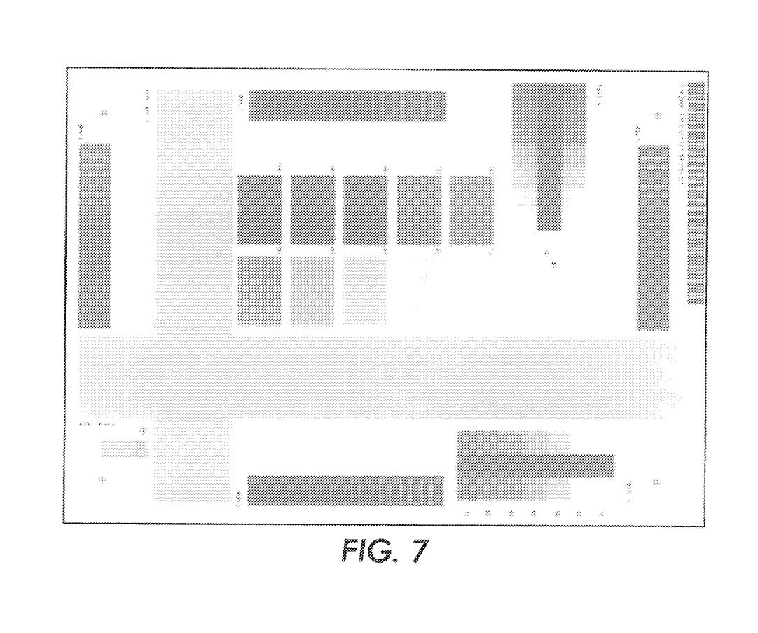

As shown in FIG. 7, the resulting print test showed no visible streaking and excellent image quality compared to Comparative Example 1 (FIG. 6). Unexpectedly, the thickness and uniformity of the SCS layer has an effect on image quality.

### Comparative Example 2

A relatively thick SCS coating of paraffin oil was applied over a portion of a photoreceptor drum surface. Using AFM the thickness and uniformity of the SCS layer was measured to be 133 nm±25.6 nm.

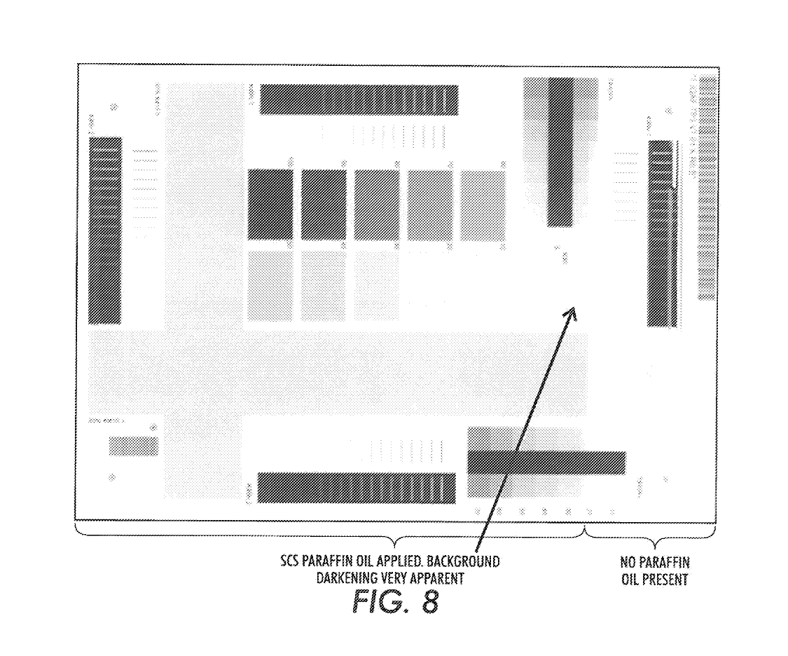

As shown in FIG. 8, the resulting print test had very apparent background darkening in the area of the print test corresponding to where the paraffin oil layer was present on the photoreceptor drum, as compared to the print test area corresponding to the portion of the photoreceptor drum surface without paraffin oil.

### Example 2

A thin SCS coating of paraffin oil was applied over a portion of a photoreceptor drum surface. Using AFM the thickness and uniformity of the SCS layer was measured to be 64.9 nm±12.9 nm.

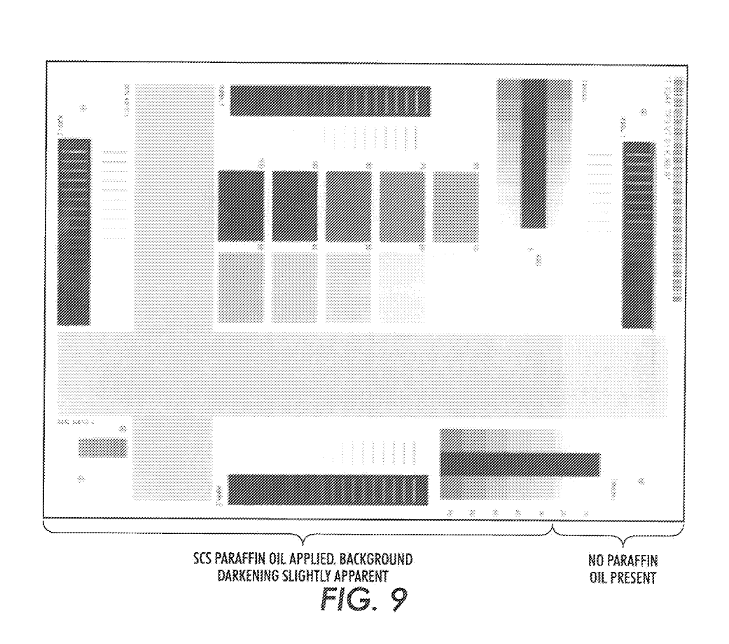

As shown in FIG. 9, the resulting print test showed only very slight background darkening in the area of the print test corresponding to where the paraffin oil layer was present on the photoreceptor drum, as compared to the print test area corresponding to the portion of the photoreceptor drum surface without paraffin oil.

As shown by multiple examples, an SCS liquid layer (paraffin oil layer) with an average thickness of 60 nm or less and a thickness uniformity of no more than 20% deviation from the average thickness surprisingly produced excellent image quality free of background darkening and streaking associated with solid powder surface control systems, while maintaining lateral charge migration (LCM) prevention, torque reduction, and toner/additive contamination reduction. The thickness and uniformity was characterized using atomic force microscopy techniques. Control over the thickness and uniformity can be obtained via delivery rate, application method, and cycling time.

To the extent that the terms “containing,” “including,” “includes,” “having,” “has,” “with,” or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. The term “at least one of” is used to mean one or more of the listed items can be selected.

Further, in the discussion and claims herein, the term “about” indicates that the values listed may be somewhat altered, as long as the alteration does not result in nonconformance of the process or structure to the illustrated embodiment. Finally, “exemplary” indicates the description is used as an example, rather than implying that it is an ideal.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume values as defined earlier plus negative values, e.g., −1, −1.2, −1.89, −2, −2.5, −3, −10, −20, and −30, etc.

It will be appreciated that variants of the above-disclosed and other features and functions, or alternatives thereof, may be combined into many other different systems or applications. Various presently unforeseen or unanticipated alternative, modifications, variations or improvements therein may be subsequently made by those skilled in the art which are also intended to be encompassed by the following claims.

What is claimed is:

1. An image forming apparatus comprising:
an imaging member having a charge retentive surface for developing an electrostatic latent image thereon, wherein the imaging member comprises:
a substrate,
a photoconductive layer disposed on the substrate, and
a surface control (SC) layer disposed on the outer surface of the imaging member, the surface control layer having a thickness of between about 5 nm and about 65 nm throughout; and
an application member for applying the SC layer to the surface of the imaging member.

2. The image forming apparatus of claim 1, wherein the thickness of the SC layer is between about 8 nm and about 60 nm throughout.

3. The image forming apparatus of claim 1, wherein the thickness of the SC layer is between about 10 nm and about 65 nm throughout.

4. The image forming apparatus of claim 1, wherein the thickness of the SC layer is between about 20 nm and about 65 nm throughout.

5. The image forming apparatus of claim 1, wherein the thickness of the SC layer is between about 30 nm and about 65 nm throughout.

6. The image forming apparatus of claim 1, wherein the SC layer comprises an alkane, a fluoroalkane, an alkyl silane, a fluoroalkyl silane, an alkoxy-silane, a siloxane, a glycol, a polyglycol, a mineral oil, a synthetic oil, a natural oil, or a mixture of two or more thereof.

7. The image forming apparatus of claim 1, wherein the SC layer comprises a paraffin oil.

8. The image forming apparatus of claim 1, wherein an image formed using the image forming apparatus has little or no background darkening or streaking visible to the naked eye.

9. The image forming apparatus of claim 1, wherein A-zone lateral charge migration (LCM) is prevented when forming an image with the image forming apparatus.

10. A surface control apparatus comprising:
an imaging member having a charge retentive surface for developing an electrostatic latent image thereon, wherein the imaging member comprises:
a substrate,
a photoconductive layer disposed on the substrate, and
a surface control (SC) layer disposed on the outer surface of the image imaging member, the surface control layer having a thickness of between about 5 nm and about 65 nm throughout.

11. The surface control apparatus of claim 10, wherein the SC layer comprises an alkane, a fluoroalkane, an alkyl silane, a fluoroalkyl silane, an alkoxy-silane, a siloxane, a glycol, a polyglycol, a mineral oil, a synthetic oil, a natural oil, or a mixture of two or more thereof.

12. The surface control apparatus of claim 10, wherein the SC layer comprises a paraffin oil.

13. The surface control apparatus of claim 10, wherein the SC layer is in the form of a liquid, a wax, a gel, or a mixture of two or more thereof.

14. The surface control apparatus of claim 10, wherein the thickness of the SC layer is between about 8 nm and about 60 nm throughout.

15. The surface control apparatus of claim 10, wherein an image formed using an image forming apparatus having the surface control apparatus installed therein has little or no background darkening or streaking visible to the naked eye.

16. The surface control apparatus of claim 10, wherein A-zone lateral charge migration (LCM) is prevented when forming an image with an image forming apparatus having the surface control apparatus installed therein.

17. A method for reducing printing defects by an image forming apparatus comprising an imaging member, the method comprising:
applying to the outer surface of the imaging member a surface control (SC) layer at an average thickness of between about 5 nm and about 65 nm, wherein the thickness is between about 5 nm and about 65 nm throughout the SC layer.

18. The method of claim 17, wherein the SC layer comprises a paraffin oil.

19. The method of claim 17, wherein the thickness of the SC layer is between about 8 nm and about 60 nm throughout.

20. The method of claim 17, wherein an image formed using the image forming apparatus has little or no background darkening visible to the naked eye.

21. The method of claim 17, wherein an image formed using the image forming apparatus has little or no streaking visible to the naked eye.
